(19) United States
(12) Patent Application Publication
(10) Pub. No.: US 2014/0250700 A1
(43) Pub. Date: Sep. 11, 2014

(54) ALUMINUM CAN PUNCTURING DEVICE

(71) Applicants: DENNIS SAMUEL LIOTTA, GREENSBURG, PA (US); BRETT JEFFREY MYLEWSKI, GREENSBURG, PA (US)

(72) Inventors: DENNIS SAMUEL LIOTTA, GREENSBURG, PA (US); BRETT JEFFREY MYLEWSKI, GREENSBURG, PA (US)

(21) Appl. No.: 14/204,014

(22) Filed: Mar. 11, 2014

Related U.S. Application Data
(60) Provisional application No. 61/776,045, filed on Mar. 11, 2013.

(51) Int. Cl. B26F 1/32

(52) U.S. Cl. CPC B26F 1/32
USPC 30/366

(57) ABSTRACT

A can puncturing device is provided. The can puncturing device includes an elongated handle assembly and a punch assembly. The elongated handle assembly includes a body with a first end, a medial portion, and a second end, the body defining a longitudinal cavity. The punch assembly is structured to penetrate an aluminum can. The punch assembly is movably disposed in the handle assembly body cavity. The punch assembly body is structured to move between two positions; a first, retracted position, wherein the punch assembly body is substantially disposed within the handle assembly, and a second position, wherein the tapered punch assembly first end is exposed.

### CROSS REFERENCE TO RELATED APPLICATION

This application claims the benefit of U.S. Provisional Patent Application Ser. No. 61/776,045, filed Mar. 11, 2013, which is incorporated by reference herein.

### BACKGROUND OF THE INVENTION

1. Field of the Invention

The present invention relates to an entertainment device and, more specifically, to a device for puncturing aluminum cans.

2. Background Information

Consumption of alcoholic beverages has been a part of human social interaction since before recorded history. As such, various social games involving the consumption of alcoholic beverages have been invented. Following the advent of the aluminum can for containing alcoholic beverages, primarily beer, an informal game commonly identified as “shotgunning” was created. Before discussing shotgunning, it is noted that an aluminum can typically include a generally cylindrical body having an upper end, a sidewall, and a lower end. The aluminum can upper end includes an opening device having a pivoting tab and a tear panel. The opening device is commonly, and hereinafter, identified as a “pop top.”

Shotgunning typically involves multiple participants, or participants taking turns, each of which holds an aluminum can in a horizontal orientation. A tool is then used to punch an opening in the sidewall of the aluminum can. The punched opening is disposed near the bottom end of the aluminum can opposite the pop top. Further, the opening is punched along the upper (in the horizontal orientation) surface of the aluminum can sidewall. The participants then quickly reorient the aluminum can to a vertical orientation while bringing the punched opening to their mouths. The participants then actuate the pop top. Actuating the pop top creates a passage for air to enter the aluminum can which in turn allows the liquid to rapidly drain through the punched opening. Upon consumption of liquid, or at least the majority of the liquid, the participant throws the aluminum can to the ground to signal that they are finished. As this is an informal game, many variations of the game exist.

Typically, the punched opening is created using various commonly available informal tools. That is, the “tool” is typically not a tool structured to punch metal, but is rather a misuse of device structured for other functions. One common informal tool is a key. Such informal tools have many disadvantages. For example, such informal tools tend to tear the aluminum can thereby creating sharp edges to the punched opening. Further, informal tools may catch on these sharp edges as the tool is being withdrawn, thereby causing the sharp edges to be bent outwardly. Sharp edges are dangerous when the aluminum can is brought to the participant's mouth. Further, informal tools do not create a uniform punched opening; therefore, participants tend to create punched openings having different sizes and giving those with larger punched openings an advantage (although some would argue that punching the opening is a skill associated with the game). Alternatively, tools designed for penetration may be used. These tools, however, tend to be common tools such as knives, rather than less common tools such as punches. Use of a knife in this manner, i.e. punching an opening in an aluminum can while holding the aluminum can, may be dangerous. Further, openings created by knives may also have sharp edges as knives are not designed to act as punches.

Accordingly, there is a need for a tool structured to punch an opening in an aluminum can.

### SUMMARY OF THE INVENTION

These needs, and others, are met by at least one embodiment of this invention which provides a can puncturing device including an elongated handle assembly and a punch. The elongated handle assembly includes a body with a first end, a medial portion, and a second end, the body defining a longitudinal cavity. The punch is structured to penetrate an aluminum can, the punch having a first end, a medial portion, and a second end, the punch movably coupled to the handle assembly body. The punch is structured to move between two positions, a first retracted position, wherein the punch is substantially disposed within the handle assembly, and a second position, wherein the punch first end is exposed.

### BRIEF DESCRIPTION OF THE DRAWINGS

A full understanding of the invention can be gained from the following description of the preferred embodiments when read in conjunction with the accompanying drawings in which:

FIG. 1 is an isometric view of a can puncturing device.

FIG. 2 is a detail isometric view of one embodiment of a punch first end.

FIG. 3 is an isometric view of an alternate can puncturing device.

FIG. 4 is a cross-sectional view of another embodiment of the can puncturing device.

### DESCRIPTION OF THE PREFERRED EMBODIMENTS

As used herein, the singular form of “a,” “an,” and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the statement that two or more parts or components “engage” one another shall means that the parts exert a force against one another either directly or through one or more intermediate parts or components.

As used herein, the word “unitary” means a component is created as a single piece or unit. That is, a component that includes pieces that are created separately and then coupled together as a unit is not a “unitary” component or body.

As used herein, the term “number” shall mean one or an integer greater than one (i.e., a plurality).

As used herein, a “coupling assembly” includes two or more couplings or coupling components. The components of a coupling or coupling assembly are generally not part of the same element or other component. As such the components of a “coupling assembly” may not be described at the same time in the following description.

As used herein, a “coupling” is one element of a coupling assembly. That is, a coupling assembly includes at least two components, or coupling components, that are structured to be coupled together. It is understood that the elements of a coupling assembly are compatible with each other. For example, in a coupling assembly, if one coupling element is a snap socket, the other coupling element is a snap plug.

As used herein, “correspond” indicates that two structural components are sized and shaped to be similar to each other and may be coupled with a minimum amount of friction. Thus, an opening which “corresponds” to a member is sized slightly larger than the member so that the member may pass through the opening with a minimum amount of friction. This definition is modified if the two components are said to fit “snugly” together or “snuggly correspond.” In that situation, the difference between the size of the components is even smaller whereby the amount of friction increases. If the element defining the opening and/or the component inserted into the opening are made from a deformable or compressible material, the opening may even be slightly smaller than the component being inserted into the opening. This definition is further modified if the two components are said to “substantially correspond.” “Substantially correspond” means that the size of the opening is very close to the size of the element inserted therein. That is, not so close as to cause substantial friction, as with a snug fit, but with more contact and friction than a “corresponding fit,” i.e. a “slightly larger” fit.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

As used herein, “structured to [verb]” means that the identified element or assembly has a structure that is shaped, sized, disposed, coupled and/or configured to perform the identified verb. For example, a member that is “structured to move” is movably coupled to another element and includes elements that cause the member to move or the member is otherwise configured to move in response to other elements or assemblies.

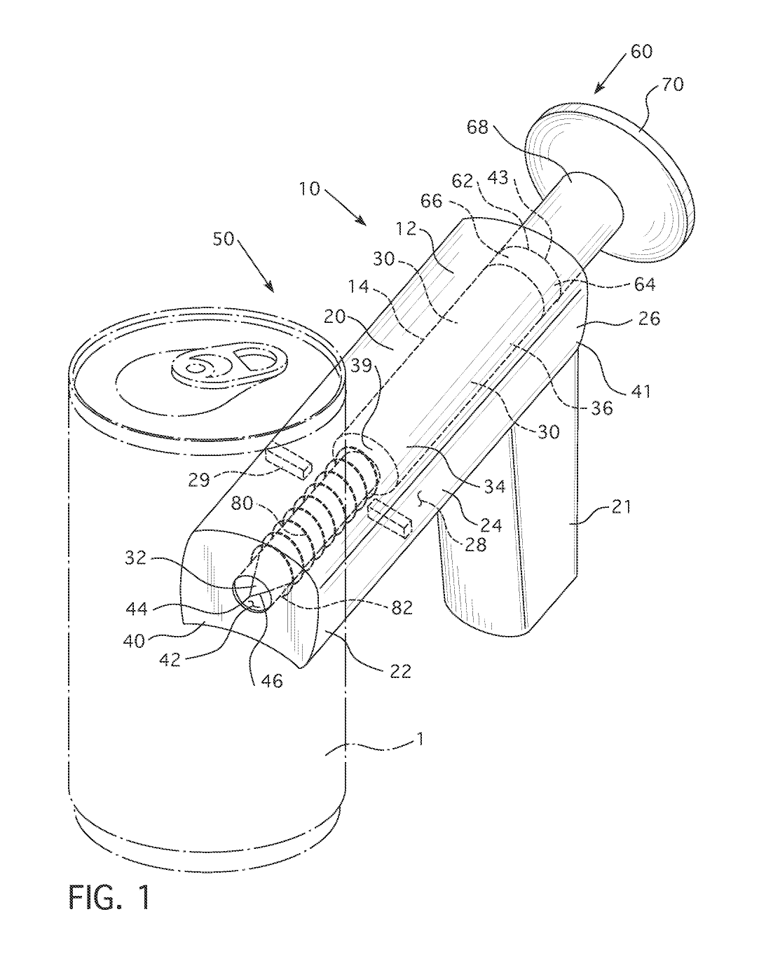

In one exemplary embodiment of the device, shown in FIG. 1, a can puncturing device 10 includes an elongated handle assembly 12 and a punch assembly 14. The elongated handle assembly 12 includes a body 20 with a first end 22, a medial portion 24, and a second end 26. The handle assembly body 20 defines a longitudinal cavity 28. The handle assembly body cavity 28 may be of any cross-sectional shape but is, in an exemplary embodiment, generally circular. As shown in FIG. 1, the handle assembly body 20 may include a radially extending portion 21, whereby the handle assembly body 20 is shaped similar to a pistol. Alternatively, the handle assembly body 20 may include two radially extending tabs (not shown) adjacent to the handle assembly body second end 26, in a manner similar to a syringe. The handle assembly body first end 22 includes an axial sidewall 40. The handle assembly body first end axial sidewall 40 may be arcuate. That is, the handle assembly body first end axial sidewall 40 may have a curvature generally corresponding to the curvature of an aluminum can 1. The handle assembly body first end axial sidewall 40 may include an axial opening 42 sized to allow the punch assembly body 30, discussed below, to pass therethrough. The handle assembly body second end 26 may include an axial sidewall 41 as well. The handle assembly body second end axial sidewall 41 may include an axial opening 43 sized to allow a plunger 62, discussed below, to pass therethrough.

The punch assembly 14 is structured to penetrate an aluminum can 1. The punch assembly 14 includes a body 30 having a first end 32, a medial portion 34, and a second end 36. The punch assembly body 30 may have any cross-sectional shape but, in an exemplary embodiment, has a generally circular cross-sectional shape with a diameter of about 0.75 inch. The punch assembly body 30 is movably coupled to said handle assembly body 20. In an exemplary embodiment, the punch assembly body 30 is movably disposed in the handle assembly body cavity 28. Thus, the punch assembly body 30 is structured to move between two positions; a first, retracted position, wherein the punch assembly body 30 is substantially disposed within the handle assembly 12, and a second position, wherein the punch assembly first end 32 is exposed. In operation, the can puncturing device 10 is held against an aluminum can with the punch assembly body 30 in the first position. The user then moves the punch assembly body 30 to the second position wherein the punch assembly first end 32 penetrates the aluminum can 1.

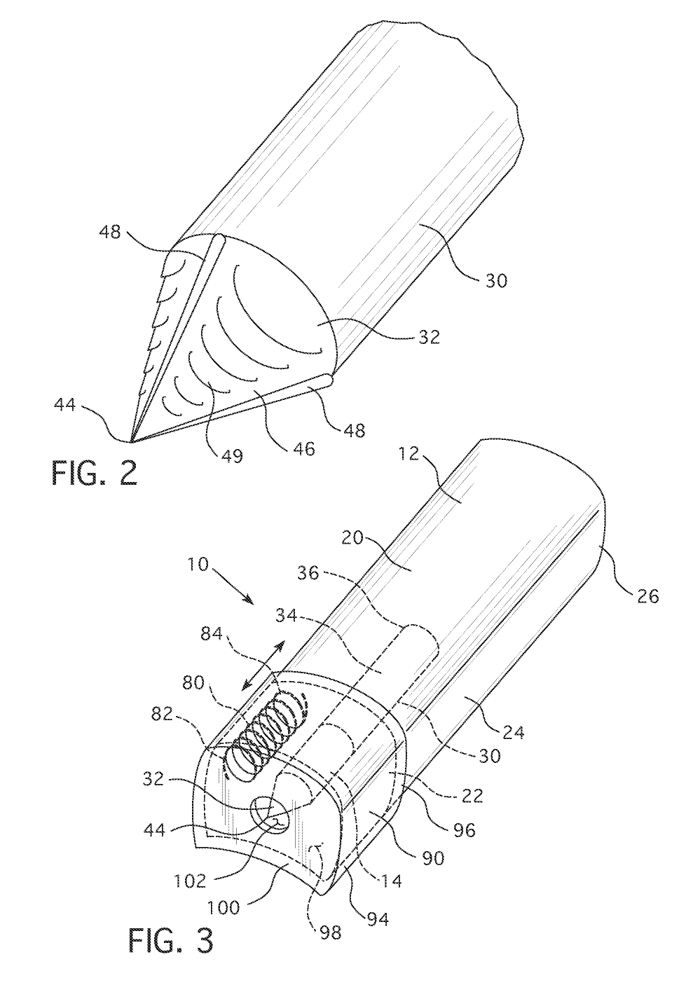

The punch assembly body 30 may be made of metal or a hard plastic. The punch assembly body medial portion 34 and punch assembly body second end 36 are sized and shaped to correspond to the handle assembly body cavity 28. Thus, the punch assembly body 30 may move, and more specifically slide, in the handle assembly body cavity 28. The punch assembly body first end 32 is generally tapered to a point. More specifically, the punch assembly body first end 32 may be generally conical. In this configuration, the punch assembly body first end 32 is structured to create an opening having a blunt edge. In another embodiment, the punch assembly body first end 32 includes a point 44 and a curling structure 46. For example, in one exemplary embodiment, shown in FIG. 2, the curling structure 46 includes a plurality of ridges 48 with flutes 49 (arcuate surfaces) therebetween. The flutes 49 may flatten out (the depth of the arcs is reduced) moving in a direction away from the point 44. The flutes 49, like the punch body first end 32, are tapered, i.e. have a lesser cross-sectional area near the point 50 than at a location spaced from the point 44. Further, the flutes 49 may have concave surfaces. In this configuration, when the punch assembly body first end 32 punches the aluminum can 1, the flutes 49 will tend to curl the punctured metal inwardly. As shown in FIG. 2, there are four ridges 48 and the curling structure 46 looks similar to a Philips-head screwdriver; it is understood, however, that the disclosed concept is not limited to a specific number of ridges 48 and the disclosure of four ridges 48 is only an example.

The handle assembly 12 may further include a motion limiter 50. The motion limiter 50 is structured to limit the distance the punch assembly body 30 may travel. In an exemplary embodiment, the motion limiter 50 includes a handle assembly body flange 29 and a punch assembly body flange 39. The handle assembly body flange 29 extends inwardly from the inner surface of the handle assembly body cavity 28 into the handle assembly body cavity 28. The punch assembly body flange 39 extends outwardly from the punch assembly body medial portion 34 or punch assembly body second end 36. The handle assembly body flange 29 and the punch assembly body flange 39 are positioned such that the handle assembly body flange 29 and the punch assembly body flange 39 engage each other when the punch assembly body 30 is in the second position. The engagement of the handle assembly body flange 29 and the punch assembly body flange 39 cause the motion of the punch assembly body 30 to stop. Thus, the motion limiter 50 limits the length of the exposed punch assembly body first end 32 when the punch assembly body 30 is in the second position.

The handle assembly 12 may further include an actuator assembly 60 structured to move the punch assembly body 30 between the first and second positions. The actuator assembly 60 includes a plunger 62 having an elongated body 64 with a first end 66 and a second end 68. The plunger body 64 may have any cross-sectional shape but is, in an exemplary embodiment, a generally circular cross-section. The plunger body 64 extends through the handle assembly body second end axial opening 43. The plunger body first end 66 is coupled to, and in one embodiment directly coupled to, the punch assembly body second end 36. In an alternate embodiment, the punch assembly body 30 and the plunger body 64 are unitary. Thus, the plunger body first end 66 is disposed within the handle assembly body cavity 28. The plunger body second end 68 is disposed outside of the handle assembly body cavity 28. The plunger body second end 68 may include a pad 70 having a greater cross-sectional area than the plunger body 64. In use, a user may apply pressure to the plunger pad 70 to move the plunger body 64 which also moves the punch assembly body 30.

The actuator assembly 60 may also include a spring 80. The spring 80, as shown, is a compression spring 80 and includes a first end 82 and a second end 84. The spring 80 is disposed about the plunger body 64. The spring first end 82 is coupled to, and in one embodiment directly coupled to, the inner side of handle assembly body axial sidewall 40. The spring second end 84 is coupled to, and in one embodiment directly coupled to, the punch assembly body flange 39. In this configuration, the spring 80 is structured to move the punch assembly body 30 from the second position to the first position.

In another embodiment, shown in FIG. 3, the handle assembly 12 includes a sheath 90. The sheath 90 includes an elongated body 92 having a first end 94 and a second end 96. The sheath body 92 defines a longitudinal cavity 98. The sheath body cavity 98 is sized to fit about the handle assembly body 20. The sheath body first end 94 includes an axial shield member 100. The shield member 100 includes an opening 102 and, in an exemplary embodiment, the opening 102 is disposed centrally on the shield member 100. The sheath body second end 96 is open. In this configuration, the handle assembly body 20, and more specifically the handle assembly body first end 22 may be, and is, disposed in the sheath body cavity 98. In this embodiment, the actuator spring 80 is a compression spring 80 (shown schematically) disposed between the handle assembly body first end 22 and the inner surface of the axial shield member 100.

In this embodiment, the punch assembly body 30 is coupled, an in an exemplary embodiment fixed, to the handle assembly body 20 with the punch assembly body 30 extending from the handle assembly body first end 22. In an alternate embodiment, the handle assembly body 20 and the punch assembly body 30 are unitary.

In this configuration, the sheath body 92 is structured to move between a first position, wherein the sheath body first end 94 extends beyond the punch assembly body first end 32, and, a second position, wherein the sheath body first end 94 is disposed between the punch assembly body first end 32 and the handle assembly body first end 22. The punch assembly body 30 passes through the shield member opening 102 when the sheath body 92 moves to the second position.

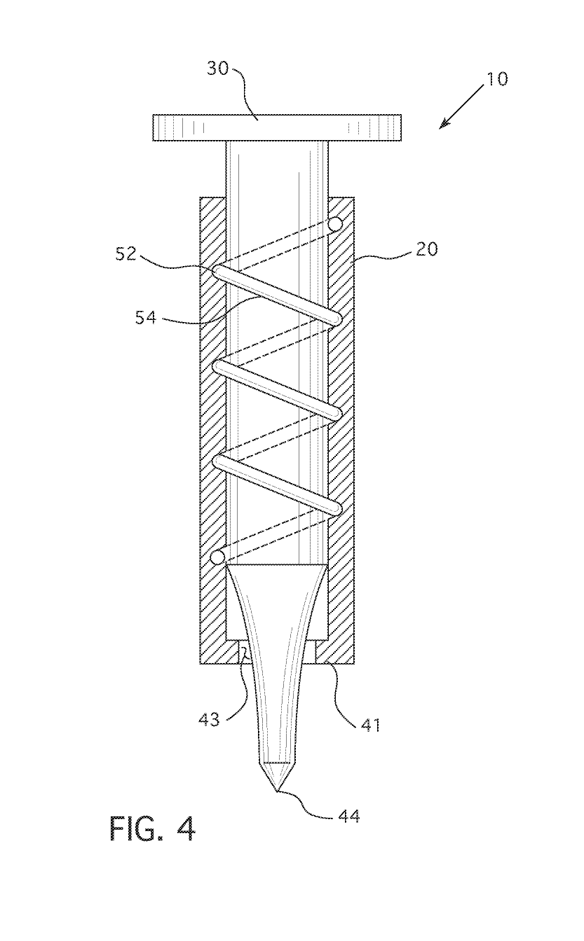

In another embodiment, shown in FIG. 4, the inner surface of handle assembly body cavity 28 and punch assembly body 30 are threaded. That is, handle assembly body cavity 28 includes a spiral groove 52 and punch assembly body 30 includes a spiral rib 54. Handle assembly body spiral groove 52 and punch assembly body spiral rib 54 correspond to each other. The pitch of handle assembly body spiral groove 52 and punch assembly body spiral rib 54 is, in an exemplary embodiment, between about 90 degrees per each inch of punch assembly body 30 length and 720 degrees per each inch of punch assembly body 30 length. It is noted that the locations of the ridge and groove may be reversed.

While specific embodiments of the invention have been described in detail, it will be appreciated by those skilled in the art that various modifications and alternatives to those details could be developed in light of the overall teachings of the disclosure. For example, while the description refers to an aluminum can 1, the can puncturing device 10 may be used on any type of container. Accordingly, the particular arrangements disclosed are meant to be illustrative only and not limiting as to the scope of invention which is to be given the full breadth of the claims appended and any and all equivalents thereof.

What is claimed is:

1. A can puncturing device comprising:
an elongated handle assembly including a body with a first end, a medial portion, and a second end, said handle assembly body defining a longitudinal cavity;
a punch assembly structured to penetrate an aluminum can, said punch assembly including a body with a first end, a medial portion, and a second end, said punch assembly movably coupled to said handle assembly body; and
said punch assembly body structured to move between two positions, a first retracted position, wherein said punch assembly body is substantially disposed within said handle assembly, and a second position, wherein said punch assembly first end is exposed.

2. The can puncturing device of claim 1 wherein said punch assembly first end is structured to create an opening having a blunt edge.

3. The can puncturing device of claim 1 wherein said punch assembly first end includes a point and a curling structure.

4. The can puncturing device of claim 3 wherein said curling structure includes a plurality of ridges with flutes.

5. The can puncturing device of claim 1 wherein:
said handle assembly first end includes an axial shield sidewall; and
said handle assembly first end axial sidewall being arcuate.

6. The can puncturing device of claim 5 wherein:
said handle assembly includes an actuator assembly; and
said actuator assembly structured to move said punch assembly between said first and second positions.

7. The can puncturing device of claim 65 wherein said actuator assembly includes a spring structured to move said punch assembly from said second position to said first position.

8. The can puncturing device of claim 6 wherein:
said actuator assembly includes a plunger, said plunger having a first end and a second end;
said plunger partially disposed in said handle assembly body cavity;
said plunger first end coupled to said punch assembly second end; and
said plunger second end extending from said handle assembly body second end.

9. The can puncturing device of claim 1 wherein said elongated handle assembly body includes a radially extending portion.

10. The can puncturing device of claim 1 wherein:
said handle assembly includes a motion limiter; and
said motion limiter structured to limit the distance the punch assembly body travels between said first position and said second position.

11. A can puncturing device comprising:
an elongated handle assembly including a body and a sheath;
said handle assembly body including a first end, a medial portion, and a second end, said handle assembly body defining a longitudinal cavity;
said sheath including an elongated body having a first end and a second end, said sheath body defining a longitudinal cavity;
said sheath body first end including a shield member having an opening;
said sheath body cavity sized to correspond to the outer cross-sectional area of the handle assembly body;
said handle assembly body slidably disposed in said sheath body cavity;
a punch assembly structured to penetrate an aluminum can, said punch assembly having a first end, said punch assembly coupled to said handle assembly body;
said punch assembly disposed in said handle body cavity with said punch assembly first end extending from said handle body first end; and
said sheath body structured to move between a first position, wherein said sheath body first end extends beyond said punch assembly body first end, and, a second position, wherein said sheath body first end is disposed between said punch assembly body first end and said handle assembly body first end.

12. The can puncturing device of claim 11 wherein:
said handle assembly further includes a spring disposed between said handle assembly body and said sheath body; and
said spring structured to move said sheath body from said second position to said first position.

13. The can puncturing device of claim 11 wherein said punch assembly first end is structured to create an opening having a blunt edge.

14. The can puncturing device of claim 11 wherein said punch assembly first end includes a point and a curling structure.

15. The can puncturing device of claim 14 wherein said curling structure includes a plurality of ridges with flutes.

16. The can puncturing device of claim 11 wherein said elongated handle assembly body includes a radially extending portion.
